(19) United States
(12) Patent Application Publication
(10) Pub. No.: US 2004/0258877 A1
(43) Pub. Date: Dec. 23, 2004

(54) Robot cover

(76) Inventor: Mark D'Andreta, Royal Oak, MI (US)

Correspondence Address: HARNESS, DICKEY & PIERCE, P.L.C., P.O. BOX 828, BLOOMFIELD HILLS, MI, 48303, US

(21) Appl. No.: 10/874,909

(22) Filed: Jun. 23, 2004

Related U.S. Application Data
(60) Provisional application No. 60/480,712, filed on Jun. 23, 2003.

(51) Int. Cl. B60J 1/02

(52) U.S. Cl. 428/99

(57) ABSTRACT

A cover for an automated paint robot having a paint nozzle including a plurality of panels. A first panel has a first edge, a second edge secured to a third edge, and a fourth edge defining an opening. A second panel has a first edge secured to the first edge of the first panel, a second edge secured to a third edge, and a fourth edge. A third panel has a first edge secured to the fourth edge of the second panel, and a second edge secured to a third edge.

### CROSS REFERENCE TO RELATED APPLICATIONS

This application claims priority to U.S. Provisional Patent Application No. 60/480,712 filed Jun. 23, 2003 which is hereby expressly incorporated by reference herein in its entirety.

### FIELD OF THE INVENTION

The present invention generally relates to an apparatus for protecting a paint robot from overspray paint. More specifically, the present invention relates to improvements in a disposable, cloth robot cover.

### BACKGROUND OF THE INVENTION

Painted goods such as automobiles and the like conventionally utilize a dedicated paint area or paint room for the application of paint. The paint rooms are highly regulated to promote a quality paint finish. For example, most conventional clothing is prohibited due to the loose fibers which otherwise end up in the paint. Additionally, various lotions and other personal products are prohibited due to their adverse effect on the painting process.

In many applications, paint is applied to articles such as automobiles with automated paint robots. The robots advantageously eliminate human error, reduce labor and provide improved and repeatable quality. The application of paint with automated paint robots is necessarily associated with a degree of overspray. Some overspray of paint is required to ensure complete painting of the subject article.

It has heretofore been appreciated in the pertinent art that automated paint robots can be equipped with cloth covers to both protect the robot and reduce paint defects. In this regard, the cloth covers substantially shield the robots from paint overspray, thereby protecting the moving parts. Additionally, the cloth covers prevent the accumulation of paint that may otherwise result in the dripping of paint on the subject article. The covers can be periodically discarded and replaced.

Ongoing objectives in the pertinent art include improved cover fit to facilitate freedom of robot movement. It is also an ongoing objective to reduce material waste and associated labor costs.

### SUMMARY OF THE INVENTION

Accordingly, it is a general object of the present invention to provide an improved cover for an automated paint robot that further advances the pertinent art.

It is a more particular object of the present invention to provide an improved cover for an automated paint robot that reduces material waste during cover manufacturing through efficient layout.

It is a related object of the present invention to provide a cover for an automated paint robot that reduces labor costs associated with manufacture of the cover.

It is another object of the present invention to provide an improved cover for an automated paint robot that adequately protects the robot from paint overspray without limiting requirement motion of the paint robot.

It is a related object of the present invention to provide a cover for an automated paint robot that minimizes the number of discrete panels that must be cut and sewn during assembly.

In one particular form, the present invention provides a cover for an automated paint robot having a paint nozzle including a plurality of panels. A first panel has a first edge, a second edge secured to a third edge, and a fourth edge defining an opening. A second panel has a first edge secured to the first edge of the first panel, a second edge secured to a third edge, and a fourth edge. A third panel has a first edge secured to the fourth edge of the second panel, and a second edge secured to a third edge.

### BRIEF DESCRIPTION OF THE DRAWINGS

The present invention will become more fully understood from the detailed description and the accompanying drawings, wherein:

FIG. 1A is a front and side perspective view of a robot cover constructed in accordance with the teachings of the preferred embodiment of the present invention.

FIG. 1B is a left side view of a robot cover constructed in accordance with the teachings of the preferred embodiment of the present invention.

FIG. 1C is a rear view of a robot cover constructed in accordance with the teachings of the preferred embodiment of the present invention.

FIG. 2 is an exploded perspective view illustrating the robot cover of the preferred embodiment of the present invention.

FIG. 3 is a planar view of a first panel of a body portion of the robot cover constructed in accordance with the teachings of the preferred embodiment of the present invention shown prior to cover assembly.

FIG. 4 is a planar view of a second panel of the body portion of the robot cover constructed in accordance with the teachings of the preferred embodiment of the present invention shown prior to cover assembly.

FIG. 5 is a planar view of a third panel of the body portion of the robot cover constructed in accordance with the teachings of the preferred embodiment of the present invention shown prior to cover assembly.

FIG. 6 illustrates an exemplary layout for the first, second and third panels of the body portion of the robot cover constructed in accordance with the teachings of the preferred embodiment of the present invention shown prior to cover assembly.

### DETAILED DESCRIPTION OF THE PREFERRED EMBODIMENT

The following description of the preferred apparatus and method of the present invention is merely exemplary in nature and is in no way intended to limit the invention, its application, or uses.

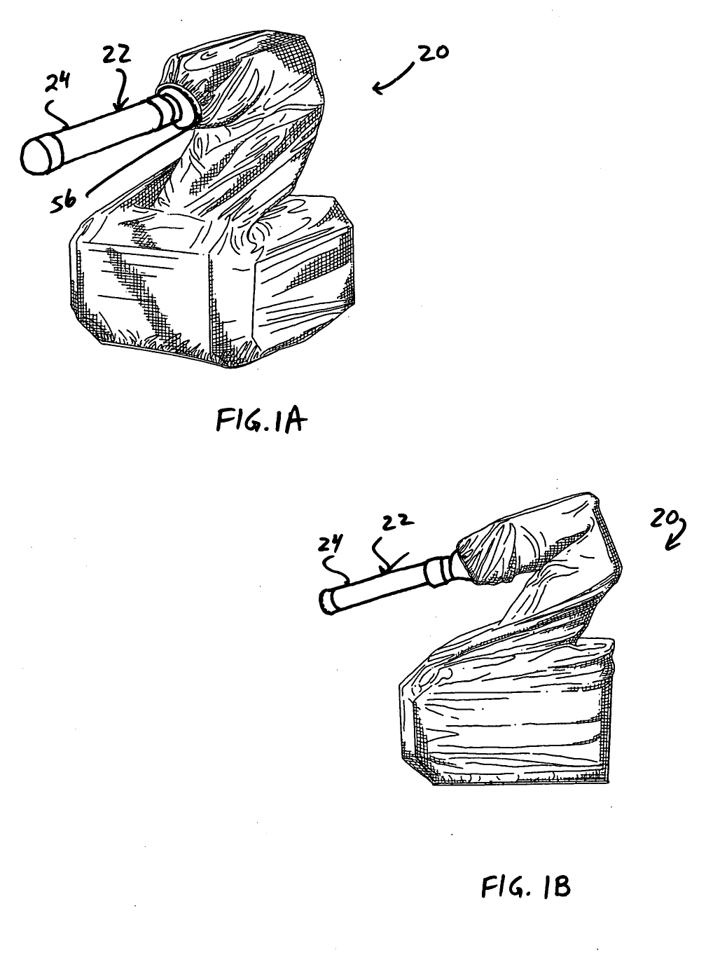

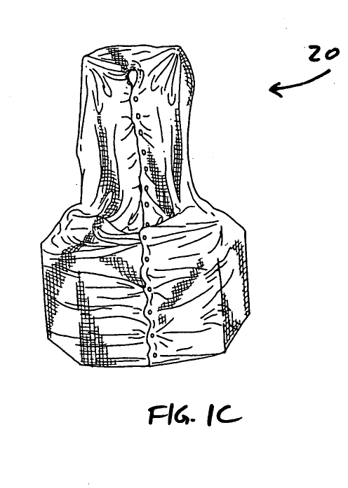

With initial reference to FIGS. 1A-1C and 2, a cover for an automated paint robot constructed in accordance with the teachings of a first preferred embodiment of the present invention is illustrated and generally identified at reference character 20. In particular, FIGS. 1A-1C show a main body portion 30 of the cover 20 operatively associated with a paint robot 22 and a paint nozzle 24 of the robot 22 extending from the main body portion 30. FIG. 2 is an exploded perspective view of the cover 20 illustrating the main body portion 30 and additional components.

In the embodiment illustrated, the cover 20 is suitable for a paint robot manufactured and sold by Fanuc Robotics under the mark P-200. The P-200 is a six axis, electric servo-driven robot. Those skilled in the art, however, will appreciate that various teachings of the present invention are equally applicable for covers intended for other types of paint robots.

As perhaps most particularly shown in the exploded view of FIG. 2, the cover 20 of the present invention is illustrated to generally include the main body portion 30. In the embodiment illustrated, the cover 20 is additionally shown to include a forearm portion 32. The cover 20 is further shown to include a pedestal base portion 34 and a rail base portion 36 that may be interchangeably used depending on the particular robot application.

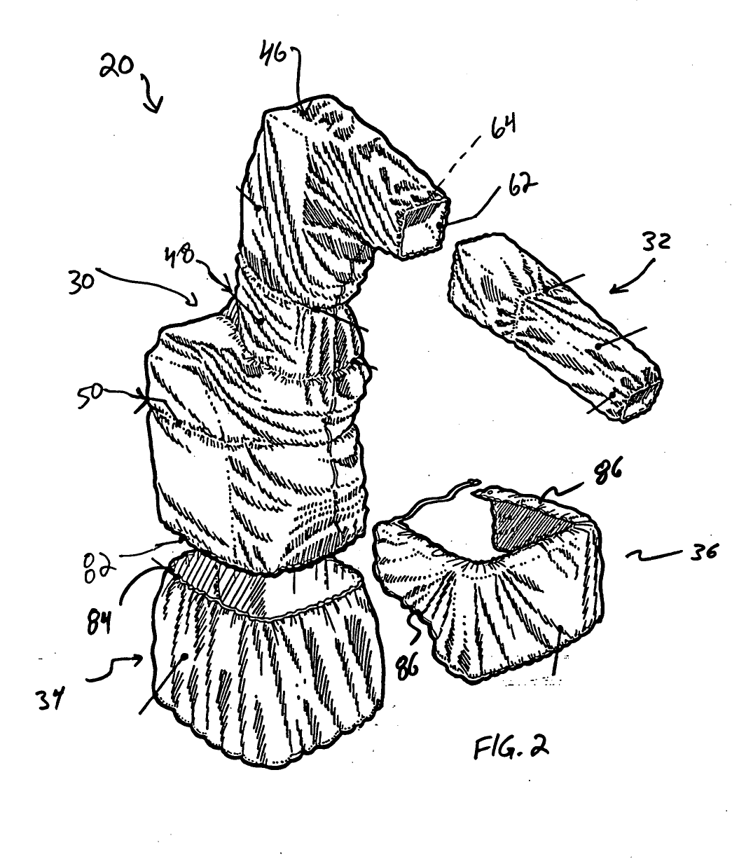

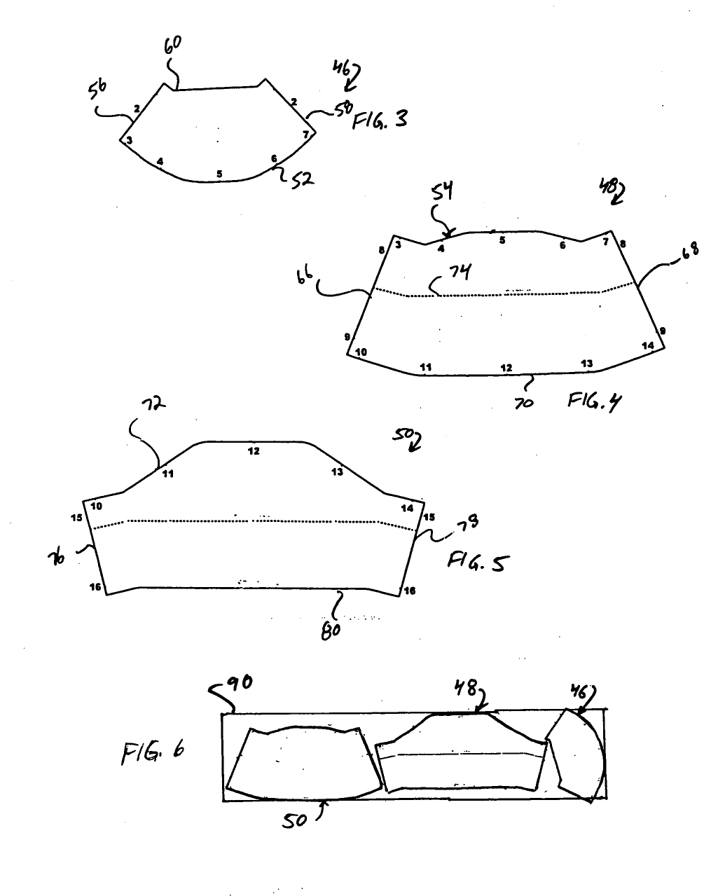

With continued reference to FIGS. 1A-1C and 2 and additional reference to FIGS. 3-5, the construction of the main body portion 30 of the cover 20 will be further described. In this regard, FIG. 3 illustrates a first panel 46 of the body portion 26 of the cover 20. FIG. 4 illustrates a second panel 48 of the body portion 26 of the cover 20. FIG. 5 illustrates a third panel 50 of the body portion 26 of the cover 20. Throughout FIGS. 3-5, reference numbers 2-16 are used to identify attachment points between the various panels 46-50. For example, the point on the first panel 46 carrying the reference character 7 is secured to the point on the second panel 48 similarly carrying the reference character 7.

The first panel 46 includes a first edge 52 sewn or otherwise suitably secured to a first edge 54 of the second panel 48. The first edge is generally convex in curvature. Attachment of the first edge 52 to the first edge 54 creates a hood for the robot 22. The first panel 46 additionally includes opposing second and third edges 56 and 58 that are sewn or otherwise suitably secured to one another. Prior to assembly, the second and third edges 56 and 58 are oriented at an angle between approximately 80 and 90 degrees relative to one another. When the second and third edges 56 and 58 are secured to one another, the first panel 46 surrounds an arm of the robot 22 and a fourth edge 60 of the first panel 46 defines a generally rectangular opening 62 (see FIG. 2) for accommodating the arm of the robot 22. The first edge 52 is generally oriented in a horizontal plane. The second and third edges 56 and 58 are oriented vertically along an underside of the arm 24. An elastic band 64 is carried by the first panel 46 adjacent the opening 62 which assists conformance of the opening 62 to the shape of the robot 22.

The second panel 48 additionally includes second and third edges 66 and 68. The second and third edges 66 and 68 are releasable secured to each other with buttons or snaps (see FIG. 3). A fourth or lower edge 70 of the second panel 48 is sewn or otherwise suitably secured to a first or upper edge 72 of the third panel 50. An elastic braid 74 is secured to the second panel 48. When fitted to the robot 22, the first and fourth edges 54 and 70 are oriented generally horizontal and the second and third edges 76 and 78 are oriented generally vertical. In the embodiment illustrated, the seam joining the second and third edges 76 and 78 is at the front of the robot 22.

The third panel 50 additionally includes second and third edges 76 and 78. The second and third edges 76 and 78 are releasably secured to each other with buttons or snaps (see FIG. 3). A fourth edge 80 surrounds a lower portion of the base of the robot 22. An elastic band 82 (see FIG. 2) is preferably secured to the third panel of the cover 20 adjacent the fourth edge 80.

The pedestal base portion 34 of the cover 20 is generally rectangular in shape. The pedestal base portion 34 includes an upper edge 84 which is generally linear. An elastic band is preferably carried by the upper edge 84. The pedestal base portion 34 circumferentially surrounds a base of the paint robot 22. Opposing edges (not particularly shown) of the pedestal base 34 are sewn or otherwise secured to one another.

The rail base portion 36 is similarly constructed to the pedestal base portion 34 and is alternatively used for applications in which the robot 22 is mounted on a rail. Distinct from the pedestal base portion 34, the rail base portion 36 includes lateral sides 86 that accommodate translation of the robot 22. Additionally, the rail base portion 36 includes an open back side.

Turning to FIG. 6, an exemplary layout for the first, second and third panels 46, 48 and 50 is illustrated prior to cutting of the panels 46, 48 and 50. The panels 46, 48 and 50 are laid out on a single piece of fabric 90. The shapes of the panels 46, 48 and 50 contribute to a material layout that significantly reduces fabric scrap.

Accordingly, a cover for an automated paint robot is provided that both retains the full function of the robot and reduces the amount of fabric waste.

The description of the invention is merely exemplary in nature and, thus, variations that do not depart from the gist of the invention are intended to be within the scope of the invention. Such variations are not to be regarded as a departure from the spirit and scope of the invention.

We claim:

1. A cover for an automated paint robot having a paint nozzle, the cover constructed of a plurality of panels, the cover comprising:
a first panel having a first edge, a second edge secured to a third edge, and a fourth edge defining an opening;
a second panel having a first edge secured to the first edge of the first panel, a second edge secured to a third edge, and a fourth edge; and
a third panel having a first edge secured to the fourth edge of the second panel, and a second edge secured to a third edge.

2. A cover for an automated paint robot having a paint nozzle of claim 1, wherein the opening is generally rectangular and the fourth edge of the first panel includes a first linear portion that defines three sides of the opening and second and third linear portions that cooperate to define a fourth side of the opening.

3. A cover for an automated paint robot having a paint nozzle of claim 1, wherein the first edge of the second panel is secured to the first edge of the first panel along a generally horizontal seam.

4. A cover for an automated paint robot having a paint nozzle of claim 1, wherein the second and third edges of the first panel are secured along a generally vertical seam.

5. A cover for an automated paint robot having a paint nozzle of claim 1, wherein the second and third edges of the second panel are releasable secured to each other with a plurality of fasteners.

6. A cover for an automated paint robot having a paint nozzle of claim 5, wherein the plurality of fasteners are vertically arranged at a rear side of the robot.

7. A cover for an automated paint robot having a paint nozzle of claim 1, in combination with the automated paint robot.
